(19) United States
(12) Patent Application Publication
(10) Pub. No.: US 2021/0018026 A1
(43) Pub. Date: Jan. 21, 2021

(54) Tolerance Equalizing Device

(71) Applicant: WITTE Automotive GmbH, Velbert (DE)

(72) Inventor: Harry Purwin, Ratingen (DE)

(73) Assignee: WITTE Automotive GmbH, Velbert (DE)

(21) Appl. No.: 16/955,296

(22) PCT Filed: Dec. 5, 2018
(86) PCT No.: PCT/EP2018/083678

§ 371 Date: Jun. 18, 2020

(30) Foreign Application Priority Data
Dec. 22, 2017 (DE) 10 2017 131 235.8

(51) Int. Cl. F16B 5/02

(52) U.S. Cl. CPC F16B 5/025; F16B 33/006; F16B 5/0233

(57) ABSTRACT

The invention relates to an apparatus for compensating tolerances between two components to be connected to one another, comprising a threaded element fastenable to a first component; a threaded bolt that has a first threaded section, which is in a first threaded engagement with the threaded element, a bolt collar and a second threaded section; and a threaded nut which can be brought into a second threaded engagement with the second threaded section, wherein the first threaded engagement and the second threaded engagement are formed in opposite senses; and wherein a friction locking or a form fit between the threaded bolt and the threaded nut can be produced by the threaded nut such that the threaded bolt is movable relative to the threaded element when the threaded nut is screwed onto the second threaded section.

### FIELD OF THE INVENTION

The present invention relates to an apparatus for compensating tolerances between two components to be connected to one another.

### BACKGROUND

Such an apparatus is generally known and is, for example, used in automobile construction to bridge or compensate a spacing present between two components on the connection of the components, said spacing being able to vary due to production tolerances and therefore not being exactly known in advance.

### SUMMARY

It is the underlying object of the invention to provide a tolerance compensation apparatus which is characterized by a particularly simple design and which is suitable for applications in which the one component is already to be provided with a stud bolt when it is delivered to the site of the connection with the second component.

An apparatus having the features of claim 1 is provided to satisfy the object.

The apparatus in accordance with the invention for compensating tolerances between two components to be connected to one another comprises a threaded element fastenable to a first component; a threaded bolt that has a first threaded section, which is in a first threaded engagement with the threaded element, a bolt collar and a second threaded section; and a threaded nut which can be brought into a second threaded engagement with the second threaded section, wherein the first threaded engagement and the second threaded engagement are formed in opposite senses; and wherein a friction locking or a form fit between the threaded bolt and the threaded nut can be produced by the threaded nut such that the threaded bolt is movable relative to the threaded element when the threaded nut is screwed onto the second threaded section.

The invention is based on the general idea of providing a threaded bolt having opposed threaded sections and a threaded nut, instead of a connection screw which is provided for connecting the components and which is conventionally plugged through a tolerance compensation apparatus, and of using the screwing of the threaded nut onto the second threaded section of the threaded bolt such that—due to an increased friction locking or form fit between the threaded nut and the threaded bolt and the opposed threaded sections—the threaded bolt automatically unscrews from the threaded element or screws off from the threaded element until the bolt collar comes into contact with the second component, whereby a further rotation of the threaded bolt is blocked and the threaded nut can be tightened as a result.

In accordance with the invention, the tolerance compensation is therefore implemented by the connection means itself, i.e. by the threaded bolt, so that a conventionally present base element and a compensation element can be omitted, whereby not only the design and function of the tolerance compensation apparatus in accordance with the invention is simplified, but a particularly compact construction is also achieved. Furthermore, a connection of the first and second components which is sealed off against external influences and which cannot be easily produced by means of conventional tolerance compensation apparatus can be particularly simply implemented by the tolerance compensation apparatus in accordance with the invention.

In addition, the threaded bolt screwed into or onto the threaded element can be easily pre-assembled at the first component by rotationally fixedly fixing the threaded element to the component in a suitable manner, for example, by means of a pressing in, a gluing in or gluing on, an injection or molding on, a screwing in or screwing on, a clipping in or clipping on or by means of a bayonet fastening. It is understood that other suitable joining methods can also be considered.

Advantageous embodiments of the invention can be seen from the dependent claims, from the description and from the drawing.

So that the threaded nut can be screwed clockwise onto the threaded bolt in the usual manner, the first threaded section advantageously forms a left-hand thread and the second threaded section forms a right-hand thread. Generally, a reverse constellation is, however, also conceivable according to which the first threaded section forms a right-hand thread and the second threaded section forms a left-hand thread.

In accordance with an embodiment, the first threaded section forms an external thread, whereas the threaded element comprises a threaded bushing. The threaded bushing can be designed in a single part or in multiple parts and can, for example, be formed from a metal material or plastic material or from a combination of metal parts and plastic parts. However, in accordance with an alternative embodiment, the first threaded section can also form an internal thread and the threaded element can comprise a stud bolt.

If both the first threaded section and the second threaded section each form an external thread, the threaded sections can thus be separated from one another by the bolt collar. If, in contrast, the first threaded section forms an internal thread and the second threaded section forms an external thread, the threaded sections can at least partly overlap, viewed in the axial direction.

The bolt collar preferably forms a contact surface for contact with the second component. The threaded bolt can be supported at the second component via the contact surface if said threaded bolt has moved sufficiently far along the threaded element to bridge the spacing between the first component and the second component.

For a reduction of the force which the bolt collar abutting the second component exerts on the second component in the axial direction and for a safe application of the necessary tightening torque of the threaded nut, the contact surface is advantageously formed such that a contact between the bolt collar and the second component is in any event ensured in the region of the outer periphery of the bolt collar.

For an ideal force transmission between the second component and the threaded bolt, the contact surface is ideally adapted to a corresponding surface region of the second component. The contact surface of the bolt collar can be planar, for example. In accordance with an embodiment, the contact surface of the bolt collar is oriented at a right angle to a longitudinal central axis of the threaded bolt. Alternatively, the contact surface can, however, also extend obliquely to a longitudinal central axis of the threaded bolt, for example, in order to ensure an additional tensioning of the components to be connected.

In accordance with a further embodiment, the contact surface is provided with a sealing element to give the threaded bolt a sealing function that enables a wet space/dry space separation.

The threaded nut preferably also forms a contact surface for contact with the second component. The contact surface of the threaded nut can, for example, be formed by a radially outwardly projecting collar. Similarly to in the case of the contact surface of the threaded bolt, the contact surface of the threaded nut is ideally also adapted to a corresponding surface region of the second component. Accordingly, the contact surface of the threaded nut can also be oriented at a right angle to a longitudinal central axis of the threaded bolt or can extend obliquely to a longitudinal central axis of the threaded bolt.

In general, the threaded bolt is moved relative to the threaded element on the screwing of the threaded nut onto the threaded bolt if the second threaded engagement is more difficult than the first threaded engagement, i.e. the friction in the second threaded engagement is greater than in the first threaded engagement or if a form fit is present in the second threaded engagement.

In accordance with an embodiment, the threaded nut has a friction element for producing a friction locking between the threaded bolt and the threaded nut for this purpose.

For example, an internal thread of the threaded nut can be arranged in a section facing the bolt collar and the friction element can be arranged in a section of the threaded nut remote from the bolt collar. In this manner, the threaded nut can first be easily screwed onto the threaded bolt for an initial connection thereto before the friction element comes into engagement with the threaded bolt and provides an increased resistance or an increased friction between the threaded nut and the threaded bolt by which the threaded bolt is taken along and is moved relative to the threaded element until the bolt collar abuts the second component. It is understood that the friction element is preferably rotationally fixedly supported in the threaded nut for the desired taking along of the threaded bolt and that the force exerted on the threaded bolt by the friction element is ideally selected such that the threaded bolt can indeed be rotated relative to the threaded element, but the threaded nut can nevertheless still be tightened by an admissible torque when the bolt collar has come into contact with the second component and the threaded bolt cannot be rotated further.

The friction element can be a spring element. For example, the spring element can be formed by a spring metal sheet that is bent over in a U shape. Alternatively, the spring element can be formed by a spring metal sheet that is bent over in a ring shape and that has a plurality of radially inwardly projecting lugs. Such a ring-shaped spring element contributes to a centering of the threaded bolt in the threaded nut, in particular when the lugs are arranged evenly distributed, viewed in the peripheral direction. It is understood that other suitable designs of the spring element are generally also conceivable. Furthermore, the friction element can be formed from a plastic material or a rubber material.

In general, the tolerance compensation apparatus in accordance with the invention also works with a threaded nut which does not have an additional friction element. For example, the threaded nut can be a standard nut, for example a typical hexagon nut, whereby the tolerance compensation apparatus becomes less expensive overall. In this case, the torque required to move the threaded bolt relative to the threaded element is transmitted to the threaded bolt by the threaded nut screwed onto the threaded bolt at the latest from the moment at which the threaded nut abuts the second component and thereby raises the threaded bolt.

An increased friction in the second threaded engagement can furthermore be achieved in that a self-locking nut is used as the threaded nut. Such a threaded nut has the additional advantage that it is secured against an unintentional release in the installed state of the tolerance compensation apparatus.

If the threaded nut is not a self-locking nut but rather, for example, a typical hexagon nut or a threaded nut having an additional friction element, possibilities of securing the threaded nut against an unintentional release are thus sufficiently known to the skilled person.

In accordance with a further embodiment, a transport securing device is provided for securing the threaded bolt which is at least approximately screwed to a maximum together with the threaded element. The transport securing device prevents a release of the threaded bolt from the threaded element, in particular an unintentional unscrewing of the threaded bolt from the threaded bushing or a twisting off of the threaded bolt from the stud bolt, for example on the delivery of the tolerance compensation apparatus to a customer or when the first component with a combination of threaded bushing and threaded bolt pre-assembled thereat is transported to the second component.

The transport securing device can, for example, be implemented in that the threaded bolt, in particular with a defined torque, is screwed tight, that is in a force-fitting manner, to the threaded element, i.e. is screwed tight into the threaded bushing or onto the stud bolt. Alternatively or additionally, the transport securing device can comprise a first latching means formed at the threaded element and a corresponding second latching means formed at the bolt collar. In accordance with an embodiment, the latching means are each formed by a projection, in particular with at least one of the projections being flexible. Alternatively, the one latching means can, however, also be formed by a projection, in particular a flexible projection, and the other latching means can be formed by a groove, a flexible latching region or the like.

In accordance with a further preferred embodiment, the threaded bolt is provided with an engagement feature, in particular in the region of its end remote from the threaded element. Such an engagement feature can enable an external engagement or internal engagement and can, for example, be configured in the form of an external or internal hexagon, a cross recess, a Torx screw or the like and facilitates the screwing of the threaded bolt into the threaded bushing.

### BRIEF DESCRIPTION OF THE DRAWINGS

The invention will be described in the following purely by way of example with reference to a possible embodiment and to the enclosed drawing. There are shown:

FIG. 1 an exploded view of a tolerance compensation apparatus in accordance with a first embodiment of the invention;

FIG. 2 a perspective view of a threaded nut of the tolerance compensation apparatus of FIG. 1;

FIG. 3A a sectional view of the tolerance compensation apparatus of FIG. 1 before the connection of two components;

FIG. 3B a sectional view of the tolerance compensation apparatus of FIG. 1 during the connection of two components;

FIG. 4 an exploded view of a tolerance compensation apparatus in accordance with a second embodiment of the invention;

FIG. 5A a sectional view of the tolerance compensation apparatus of FIG. 4 before the connection of two components; and

FIG. 5B a sectional view of the tolerance compensation apparatus of FIG. 4 during the connection of two components.

### DETAILED DESCRIPTION

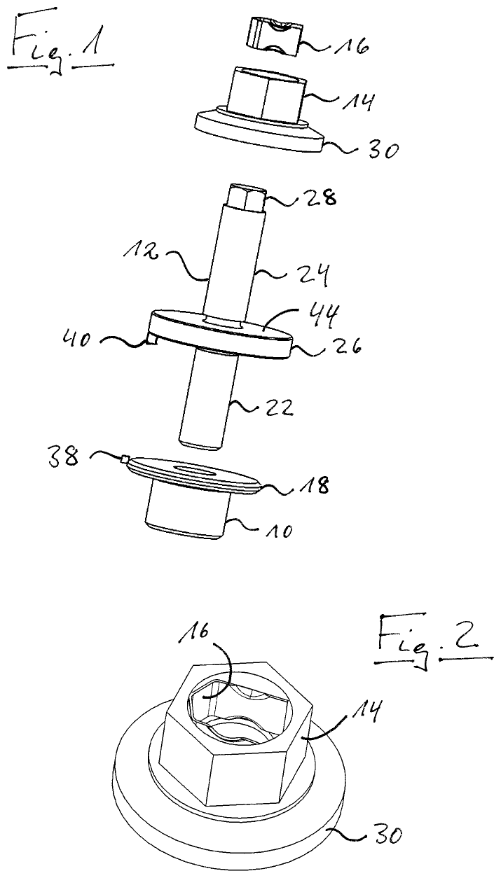

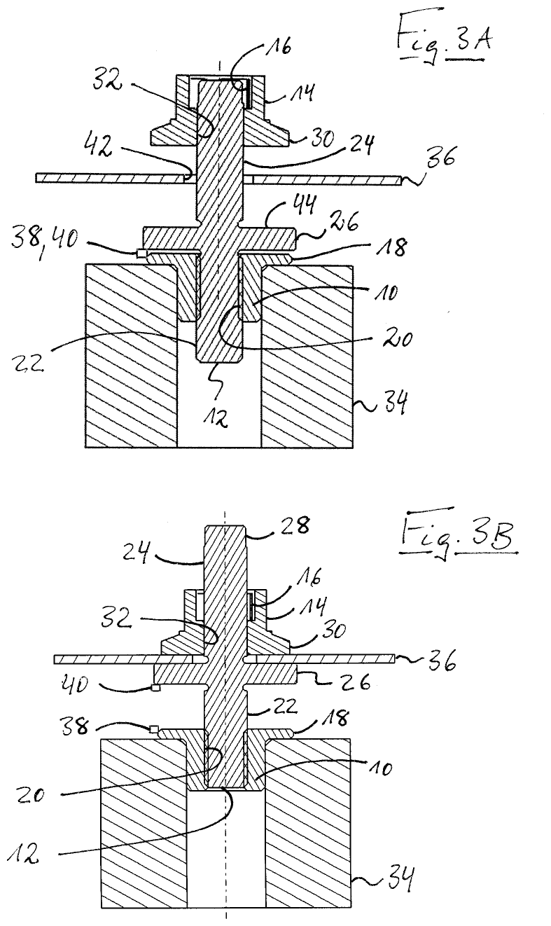

The first embodiment of a tolerance compensation apparatus shown in FIGS. 1 to 3 comprises a threaded element in the form of a threaded bushing 10; a threaded bolt 12; and a threaded nut 14 having a friction element 16.

The threaded bushing 10 is substantially cylindrical and has a radially outwardly projecting flange 18, which could, however, generally also be omitted, at its end face which faces the threaded nut 14 and which is the upper end face in the Figures. Furthermore, the threaded bushing 10 forms a left-hand internal thread 20.

The threaded bolt 12 has a left-hand first threaded section 22, which is adapted to the internal thread 20 of the threaded bushing 10, and a right-hand second threaded section 24. The first threaded section 22 and the second threaded section 24 each form an external thread and are separated from one another by a radially outwardly projecting disk-shaped bolt collar 26. In the region of its end adjacent to the second threaded section 24, the threaded bolt 12 is provided with an engagement feature 28, here in the form of an external hexagon, which facilitates the screwing of the threaded bolt 12 into the threaded bushing 10.

In the embodiment shown, the threaded nut 14 has a radially outwardly projecting collar 30 at its end face which faces the threaded bushing 10 and which is the lower end face in the Figures. In general, a threaded nut without a collar could, however, also be used.

In addition, the threaded nut 14 forms, in a lower part, a right-hand internal thread 32 adapted to the second threaded section 24 of the threaded bolt 12, whereas the friction element 16 is rotationally fixedly received in an upper part of the threaded nut 14. The friction element 16 is formed from a spring metal sheet bent over in a U shape in order to form an increased friction locking with the threaded bolt 12 when the threaded nut 14 is screwed sufficiently far onto the threaded bolt 12.

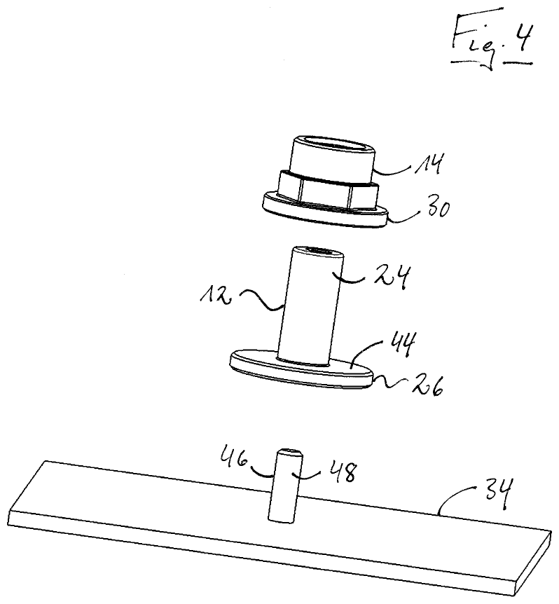

The tolerance compensation apparatus serves to connect two components 34, 36 (FIG. 3), for example, for the attachment of a headlamp to a support structure of a motor vehicle provided for this purpose. In this respect, the tolerance compensation apparatus is used as follows:

First, the threaded bushing 10 is fixed in a first component 34, for example, pressed into, glued into, injected into, clipped into or screwed into the first component 34. Then, the first threaded section 22 of the threaded bolt 12 is screwed into the threaded bushing 10, and indeed so far until the lower side of the bolt collar 26 comes at least approximately into contact with the flange 18 of the threaded bushing 10. It is understood that it is generally also possible to first screw the threaded bolt 12 into the threaded bushing 10 and then to insert the threaded bushing 10 together with the threaded bolt 12 into the first component 34.

To prevent the threaded bolt 12, which is at least approximately completely screwed into the threaded bushing 10, from unintentionally unscrewing from the threaded bushing 10, corresponding latching means 38, 40 are provided at the flange 18 and at the bolt collar 26 to form a transport securing device. In the present embodiment, the latching means 38, 40 are designed in the form of projections, wherein the projection 38 of the flange 18 is in the way of the projection 40 of the bolt collar 26, viewed in the unscrewing direction. The projection 40 of the bolt collar 26 is a rigid projection here, whereas the projection 38 of the flange 18 has a certain flexibility so that it can evade the projection 40 of the bolt collar 26 when the threaded bolt 12 is rotated by a sufficiently large torque. It is understood that other embodiments of the transport securing device can also be considered.

Next, the first component 34 provided with the threaded bushing 10 and with the threaded bolt 12 is attached to the second component 36 such that the second threaded section 24 of the threaded bolt 12 projects through a bore 42 of the second component 36 provided for this purpose.

To connect the components 34, 36, the threaded nut 14 is subsequently screwed onto the second threaded section 24 of the threaded bolt 12 which projects through the bore 42 of the second component 36. This screwing process takes place relatively easily during a first phase, namely while the internal thread 32 of the threaded nut 14 is brought into engagement with the second threaded section 24 of the threaded bolt 12. However, when the threaded bolt 12 has penetrated far enough into the threaded nut 14, it comes into contact with the friction element 16, whereby an increased friction locking is produced between the threaded bolt 12 and the threaded nut 14 and has the effect that the threaded bolt 12 is taken along by the threaded nut 14 and is unscrewed from the threaded bushing 10.

On a continued rotation of the threaded nut 14, the threaded bolt 12 is moved so far out of the threaded bushing 10 until the bolt collar 26 comes into contact with the second component 36 and prevents a further rotation of the threaded bolt 12. As soon as the movement of the threaded bolt 12 is blocked, the threaded nut 14 is tightened by applying a torque which is sufficiently high to overcome the friction locking, increased by the friction element 16, between the threaded bolt 12 and the threaded nut 14 in order to ultimately clamp the second component 36 between the bolt collar 26 and the threaded nut 14, and via the threaded bolt 12 and the threaded bushing 10, to the first component 34, wherein the maintenance of the spacing between the first component 34 and the second component 36 is ensured by the extended threaded bolt 12.

In the present embodiment, a contact surface 44 of the bolt collar 26 provided for contact with the second component 36 extends in a planar manner and substantially orthogonally to a longitudinal central axis of the threaded bolt 12. However, such a planar contact surface 44 could also be tilted slightly, i.e. by a few angular degrees, with respect to a plane orthogonal to the longitudinal central axis of the threaded bolt 12 in order to provide an additional clamping of the components 34, 36. It is furthermore understood that the contact surface 44 of the bolt collar 26 does not necessarily have to be planar, but can generally also have a curved contour adapted to the contour of the second component 36.

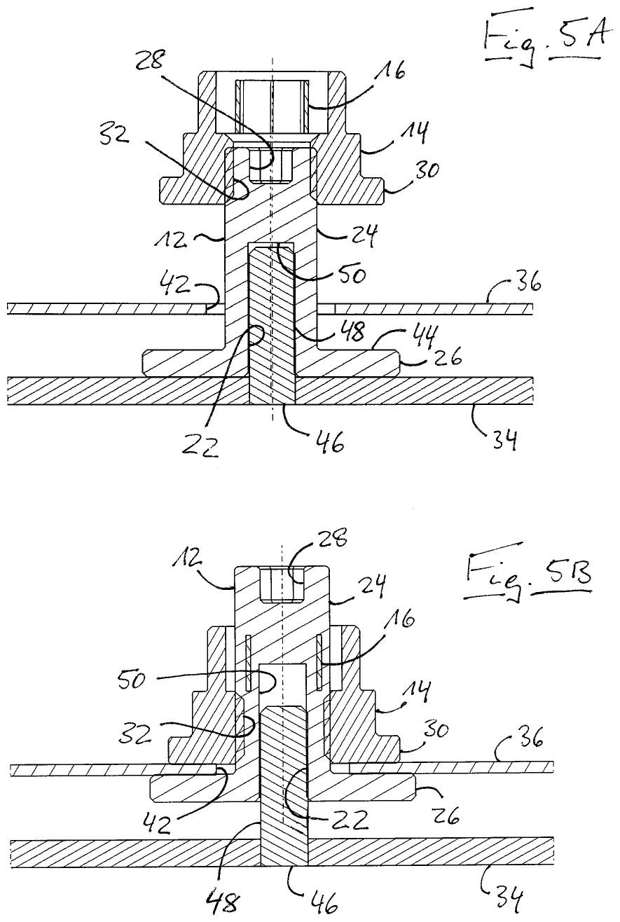

In FIGS. 4 and 5, a second embodiment of a tolerance compensation apparatus in accordance with the invention is shown which is functionally identical to the first embodiment described above and only differs therefrom in the design features described in the following.

First, the threaded element of the second embodiment is not designed in the form of a threaded bushing 10, but rather in the form of a stud bolt 46 which is rotationally fixedly attached to the first component 34 and which has an external thread 48.

Correspondingly, the threaded bolt 12 of the second embodiment has an axial threaded bore 50 which forms a first threaded section 22, here in the form of an internal thread, adapted to the external thread 48 of the stud bolt 46. The threaded bore 50 extends from an end face of the threaded bolt 12 facing the first component 34 so far into the threaded bolt 12 that the first threaded section 22 of the threaded bolt 12 partly overlaps the second threaded section 24, which is also configured as an external thread here, viewed in the axial direction.

Unlike in the first embodiment, the first threaded section 22 and the second threaded section 24 of the threaded bolt 12 are not separated from one another by the bolt collar 26 in accordance with the second embodiment. Instead, the bolt collar 26 is here arranged in the region of the end of the threaded bolt 12 facing the first component 34, and indeed such that it contacts the first component 34 when the threaded bolt 12 is completely screwed onto the stud bolt 46.

In a further difference from the first embodiment, the threaded bolt 12 in accordance with the second embodiment does not have an outwardly disposed engagement feature 28 in the region of its end remote from the first component 34, but rather has an inwardly disposed engagement feature 28, here specifically in the form of a hexagon socket.

### REFERENCE NUMERAL LIST

10 threaded bushing

12 threaded bolt

14 threaded nut

16 friction element

18 flange

20 internal thread

22 first threaded section

24 second threaded section

26 bolt collar

28 engagement feature

30 collar

32 internal thread

34 first component

36 second component

38 latching means

40 latching means

42 bore

44 contact surface

46 stud bolt

48 external thread

50 threaded bore

1. An apparatus for compensating tolerances between two components to be connected to one another, the apparatus comprising:
a threaded element fastenable to a first component;
a threaded bolt that has a first threaded section, which is in a first threaded engagement with the threaded element, a bolt collar and a second threaded section; and
a threaded nut which can be brought into a second threaded engagement with the second threaded section, wherein the first threaded engagement and the second threaded engagement are formed in opposite senses; and
wherein one of a friction locking and a form fit between the threaded bolt and the threaded nut can be produced by the threaded nut such that the threaded bolt is movable relative to the threaded element when the threaded nut is screwed onto the second threaded section.

2. The apparatus in accordance with claim 1,
wherein the first threaded section forms a left-hand thread and the second threaded section forms a right-hand thread.

3. The apparatus in accordance with claim 1,
wherein the first threaded section forms an external thread and the threaded element comprises a threaded bushing.

4. The apparatus in accordance with claim 1,
wherein the first threaded section forms an internal thread and the threaded element comprises a stud bolt.

5. The apparatus in accordance with claim 1,
wherein the bolt collar forms a contact surface for contact with the second component.

6. The apparatus in accordance with claim 5,
wherein the contact surface of the bolt collar is planar.

7. The apparatus in accordance with claim 5,
wherein the contact surface of the bolt collar is oriented at a right angle to a longitudinal central axis of the threaded bolt.

8. The apparatus in accordance with claim 5,
wherein the contact surface of the bolt collar extends obliquely to a longitudinal central axis of the threaded bolt.

9. The apparatus in accordance with claim 5,
wherein the contact surface is provided with a sealing element.

10. The apparatus in accordance with claim 5,
wherein the threaded nut forms a contact surface for contact with the second component.

11. The apparatus in accordance with claim 10,
wherein the contact surface of the threaded nut is oriented at a right angle to a longitudinal central axis of the threaded bolt.

12. The apparatus in accordance with claim 10,
wherein the contact surface of the threaded nut extends obliquely to a longitudinal central axis of the threaded bolt.

13. The apparatus in accordance with claim 10,
wherein the contact surface of the threaded nut is formed by a radially outwardly projecting collar.

14. The apparatus in accordance with claim 1,
wherein the threaded nut is one of a standard nut and a self-locking nut.

15. The apparatus in accordance with claim 1,
wherein the threaded nut has a friction element for producing a friction locking between the threaded bolt and the threaded nut.

16. The apparatus in accordance with claim 15,
wherein an internal thread of the threaded is arranged in a section facing the bolt collar and the friction element is arranged in a section of the threaded nut remote from the bolt collar.

17. The apparatus in accordance with claim 15,
wherein the friction element is a spring element.

18. The apparatus in accordance with claim 1,
further comprising a transport securing device for securing the threaded bolt which is at least approximately screwed to a maximum together with the threaded element.

19. The apparatus in accordance with claim 18,
wherein
the transport securing device comprises a first latching means formed at the threaded element; and a corresponding second latching means formed at the bolt collar.

20. The apparatus in accordance with claim 18,
wherein the threaded bolt is screwed tight to the threaded element in order to form the transport securing device.

21. The apparatus in accordance with claim 1,
wherein the threaded bolt is provided with an engagement feature.
